(19) United States
(12) Patent Application Publication
(10) Pub. No.: US 2014/0019555 A1
(43) Pub. Date: Jan. 16, 2014

(54) SYSTEMS AND METHODS FOR A SERVICE BASED SOCIAL NETWORK USING TAGGING TECHNOLOGY

(71) Applicants: Jian Cai, Marlboro, NJ (US); Simin Cai, Basking Ridge, NJ (US)

(72) Inventors: Jian Cai, Marlboro, NJ (US); Simin Cai, Basking Ridge, NJ (US)

(21) Appl. No.: 13/547,241

(22) Filed: Jul. 12, 2012

(51) Int. Cl. G06F 15/16

(52) U.S. Cl. 709/205

(57) ABSTRACT

A human-centric distributed network operating system that includes a platform for facilitating remote collaboration on a large scale is provided. The platform permits resources, in the form of data, to be tagged and the tags are structured into a hierarchy, called namespaces, that are available for facilitating service based social network applications. The tags may further be assigned colors for performing operations associated with handling certain applications, such as image related operations or graphic user interfaces. By integrating these tools into a platform, users may seamlessly communicate with others to build communities of any desired size and for any desired purpose. The human-centric distributed network operating system may be used to facilitate various service based social network applications. The platform provides a scalable product for real time communications in an open, collaborative environment.

### FIELD OF THE INVENTION

The present invention relates to systems and methods for allowing people to better communicate and collaborate together on a large scale for a more efficient and productive community.

### BACKGROUND OF THE INVENTION

Over the past several years, the amount of personal information that individuals share online has increased dramatically. Many websites provide an online community that allows people to join the online community and share personal information and interest with other members of the same online community.

Online social networking sites have also become increasingly popular. Typically, members of an online social network share data and information with existing friends and family and meet other members based on a web of online relationships. Operators of online social networking sites typically require that new members provide certain personal information to join, including contact information (e.g., email addresses, telephone numbers, etc.) and identifying information (e.g. a name, location, personal interests, age, etc.).

One consequence of online social networking is the greater ability for groups of friends, families and other acquaintances to communicate online with, and about, each other as members of a social network. For example, a group of friends may share personal information with each other about common interests, events, schedules and activity plans and may also access each others' personal information. Another benefit of online social networks is that members can more easily find others who share common interests, goals, lifestyles, etc., without being limited to an online community dedicated to a particular interest. Existing online communities (e.g., Facebook, Google+, etc.) allow members to expand their social networks, but these communities are not used for performing commercial or personal services in real time, and online social networking typically only occurs between those who have already agreed to share personal information.

In addition to online social networking, online marketplaces (e.g., Amazon and eBay) offer items for sale on a network-based marketplace. In these online marketplaces, a potential purchaser may search product offerings by multiple suppliers utilizing search engine technology employed by the relevant marketplace. A number of such online marketplaces offer automated search features that allow a user to define search terms and conditions. The online marketplace may automatically conduct a search utilizing the terms and conditions, and provide the results of these searches to the relevant user. A user can automatically be advised when items of interest become available for purchase via the online marketplace. These online marketplaces may also facilitate watching items to monitor the progress of an auction or to make an immediate purchase of the item on the network-based marketplace. These online marketplaces, however, are not used for facilitating the performance of commercial or personal services in real time on an open basis.

Modern computer networks have made large bodies of information widely and easily available. For example, search engines index many millions of web sites that are linked to the internet. A search engine executes a search query entered by a user against a data repository describing information characteristics of potentially retrievable online content and identifies candidate web pages. Search engines typically rank or score a subset of the most promising results, which are presented to the user. The shear volume of documents returned by the search query may be overwhelming to a user. Information on a specific topic that may be very valuable to the user may be difficult to locate through the use of a search engine. Furthermore, a user who is interested in information related to a specific topic typically has a finite amount of time to locate such information. It would be useful to have systems and methods that allow people to better communicate and collaborate together on a large scale for a more efficient and productive community.

### SUMMARY OF THE INVENTION

In one aspect, the present invention provides a human-centric distributed network operating system comprising a platform accessible by a user computing device for using tagged data structured into hierarchies that are processed in conjunction with rules to create and implement a collaboration among users for facilitating various service based social applications.

In another aspect, the present invention provides methods for collaborating among users in a human-centric distributed network operating system using hierarchies of tagged data for facilitating various service-based social applications.

### BRIEF DESCRIPTION OF THE DRAWINGS

FIG. 1 illustrates an exemplary arrangement of a human-centric distributed network operating system using a namespace of tags in accordance with an embodiment of the present invention.

FIG. 2 illustrates an exemplary arrangement of a system environment and a process distribution of a human-centric distributed network operating system in accordance with an embodiment of the present invention.

FIG. 3 illustrates an exemplary arrangement for using colored tags in a system environment in accordance with an embodiment of the present invention.

The drawings are exemplary, not limiting. Items that are labeled with the same reference number in multiple figures refer to the same item throughout the figures.

### DETAILED DESCRIPTION

In the following description, for purposes of explanation, numerous specific details are set forth in order to provide a thorough understanding of various embodiments of the present disclosure. It will be evident, however, to one skilled in the art that the present disclosure may be practiced without these specific details.

Sharing interests is a major activity among social networks. However, in real life social activities, we have many more activities than just sharing interests. The features of the present invention involve further collaborating with others in various social activities (e.g., daily working, shopping, and services), possibly on a very large scale. Human collaboration in various social activities on a large scale, or social collaboration, may be described as next generation social networks.

It should be apparent that in order to handle such collaboration more structured data or processes are required, e.g., business process management (BPM). Because social activities are diversified and personalized, individual opinions need to be taken into account. Human behaviors and emotions play an indispensable role in social collaborations. The collaborative process may be dynamic and environmentally dependent. As a result, the collaborative process may be modified by the people that choose to participate.

Human collaboration may be realized via communications among those who are involved in a community. A service exchange involving communications in a community facilitates human collaborations in next generation social networks. The foregoing principles may become evident with reference to the description herein.

A platform in accordance with the present invention integrates communication tools together with collaboration tools for people to build any community they want. The architecture designed for such platform allows users to have a seamless experience while utilizing various communication tools and collaboration tools to build communities of any size for any desired purpose. In particular, one advantage of the disclosed architecture is its ability to support interaction and collaboration on a large scale. Thus, the architecture is highly scalable since it can support large volumes of data and a large number of users. This enables human collaboration in an online community on a possibly large scale whereas human collaboration in real life on such a scale would be impossible.

A platform for implementing these and other exemplary applications will be described. In accordance with an embodiment of the present invention, the platform may be part of a human-centric distributed network operating system that provides a human service infrastructure for social applications. Under the structure of the present invention, both machines (e.g., computers with central processing units (CPUs)) and humans are considered to have processors. The platform provides a tag interface to resources and services that allows the dynamic construction of a user namespace. A tag is a non-hierarchical name (e.g., a bookmark or reference) assigned to anything, whether it is a piece of information, a user, a process, or anything that can play a role in the network operating system. Tags may be structured to reflect rules similar to the commonly used concept of a Semantic Web. Both tags and structures, or names and namespaces, may be shared and reused across applications and communities. Both humans and processes may generate tags. A namespace may be considered to be a hierarchy of tags available to an application in the system. Tags used in a namespace are quite similar to files (names) in a file system. Anything can be tagged, and thus shared and accessed in a human-centric distributed network operating system. As will be described, tags may also be colored so that it is more convenient for some applications. As used herein, colored tags are not necessarily assigned a color in a literal sense but are assigned identifiers that may be figuratively considered to be colors. A particular application on the platform (e.g., a social event or a human service event) can access the resources and services in its namespace even though they may be distributed throughout the network of the platform. In one embodiment, the platform may be part of a distributed operating system based on Bell Labs' Inferno system, which used a file based namespace system, whereas the platform of the present invention may use a namespace of tags.

By expanding the use of tags, a more robust system can be achieved. All information, not only text, can be structured, regardless of whether the structure is revealed. Non-textual information structure may be harder to describe, for example, image, video, music/sound, RF analog data, etc. Nevertheless, a structure may be abstracted out of information with a focus on an area of interest, and can be tagged and referenced in processing. In fact, the same information may have many structures if it is processed from various perspectives.

Tags may multiply and change over time. A tag “name” may relate to different source URLs and may come from different people. A tag may be uniquely identified when a tag “name,” the tagger (e.g., person or process), the tag URL, a time stamp associated with the tag are known. Different descriptions and different levels of abstraction may lead to many representations. Tags may also change when a source has been updated or people changed. Tags may be altered by a service provider purposely or changed by communication and collaboration technologies.

Other advantages of tags include their ability to be cataloged and their scalability. Tags may be cataloged in a manner other than by source (e.g., files, URLs, database). Tags also create another way of indexing data and are extremely scalable because of their flat structure.

Extensible Markup Language (XML) is a widely used method to markup information structures that is both human-readable and machine-readable. XML, however, requires multiple indirections, tools, or expertise in order for human to capture the meaning of structures. While XML may be used in accordance with the embodiments of the present invention, it is also possible to use a colored tag approach as described herein.

Colored tags are based on the premise of the four color map theorem that given a planar map separated into contiguous regions; no more than four colors are required to color the regions of the map so that no two adjacent regions have the same color. In this way, any pixel, any portion of an image or entire image may be assigned a color. The same image may have multiple spatially mapped arrays of bits created by different processes or different people. These multiple maps of the same images may be called layers. In certain instances, colors can also be used on a multivariate data set. For example, the multivariate data set may use two variables in a particular context. Colored tags are particularly useful for continuous regions.

A color is an area or areas of bits mask. An image may have many colors like a real map, and an image may have multiple maps. Each area of interest is named. Many types of filters (i.e., algorithms) may be used to link a color to a name. For example, a hash filter can hash the whole bits mask since all masks are different resulting in different hash values.

Colored tags have several advantages. They allow for a simple and fast system when combining the original image, colored-tags, and the lookup map. They can be considered simply the set logics on bits and can be realized via meta-programming on an image processor. Colored tags are easy to understand and can be used by humans to correlate different things. Colored tags allow images to be manipulated in certain areas with a high degree of accuracy (e.g., pop-up and zoom in colored portion) and permit a portion of images to be changed without updating the whole picture. When combined with database on names for the actual objects semantics (e.g., size, dimension, rotation, etc.), the use of color tags can achieve real life effects. For collaborative work, detailed portion or semantics can be done later, especially in certain applications, e.g., a virtual world game application. Color tags provide a way to differentiate various components of data so that the data may be assembled or combined in a desired manner.

A namespace will now be described in greater detail. As mentioned above, a namespace may be considered to be a hierarchy of tags available to an application in the system. It should be recognized that anything can be tagged in a namespace, not only resources, but also network connections, interfaces to services, users, processes, etc. A namespace, as a collection of tags, represents a diverse resource space. The disclosed system offers a unique set of operations to manage this namespace. These operations allow users and application developers to cope with complexity in today's networked environments. A namespace may be considered to be hierarchies of processes, linked together into certain structures or patterns that provide a communication channel between each of the corresponding functions and layers in the hierarchies. These processes may include a human process, a local machine process, a remote server process, a storage process, etc. A namespace is comprised of a collection of tags combined into structured processes. A namespace is self-contained and includes tags concerning persons, groups, processes (e.g., application programming interfaces (APIs)) or tasks, resources, etc. It should be clear that a person may be associated with one or many namespaces based on collaboration needs, and a namespace may include shared parts, e.g., friends, groups, the general public, etc. Furthermore, namespaces may be manipulated via set logics, such as union, bind, mount, export, import, etc., that are known to those of ordinary skill in the art.

A namespace gives a user access to interact with others' namespaces by including other people's processes in a user's namespace. The namespaces may be used without users knowing the details of how processes are distributed. The namespaces use consistent and predefined semantics on names and provide standard access controls on names. These features may be implemented as namespace primitive APIs.

The present invention also takes into account the human process. In order to perform various tasks and actions, the human mind proceeds through a process that may be described by the following steps: 1. Selection: the brain decides what information to focus on; 2. Process: the brain begins to process through the visual, auditory and sensual data it is receiving; 3. Encoding: the brain begins creating memory by screening out distractions and prioritizing attention; 4. Storage: the brain begins storing selected information in short term memory; 5. Retrieval: the brain accesses stored information; and 6. Execute: the brain chooses and implements a course of action. A few characteristics of the human mind should be mentioned. The human brain is not particularly well-suited to multi-tasking because it handles tasks in a sequential manner. When a person attempts to perform two complex cognitive tasks, the brain shifts its focus to manage one task at a time. This process is identified as “reaction-time switching costs” and represents a measurable period of time in which the brain is moving its focus from one task to another.

Turning to the use of tags in processes, it should be apparent that processes have intrinsic characteristics that may be characterized by behaviors. Example of such processes include active and passive processes, reversible processes, descriptive processes, generative processes, storage processes, deterministic processes, probabilistic or statistical processes, precautionary processes, transactional processes, synchronized processes, etc.

The common assumption that a person understanding the domain knowledge of inputs may not be true. For example, a person may expect another process of certain characteristics based on his or her experience. By tagging a process, the side logics upon inputs can be triggered and run in parallel in a non-intrusive way. Side logics may be semantic, machine-assisted, human processing, or anything else. Such a side process may be used to help understand complex logics, to assist a logic semantic process, to avoid and analyze logic faults, etc. Tags may also be used to correlate processes to reveal certain pattern of logic, for example, a piece of computer program, a person's social behavior, etc. The side logics may be implemented and used without substantial effort. They can be service, user end program libraries, or applications. For some types of collaboration, side logics may be used as rules since they enforce the required patterns that are not in the normal process pattern. This is common in certain processes, for example, business process management.

The programming used to implement the present invention may be based on the functional programming concept. Functional programming, unlike imperative programming, generally avoids side effects, which are used to modify some state or cause some observable effect. The properties and structure of functional programming are understood in the field. In addition, one of skill in the art knows that functional programming may be accomplished in languages that are not specifically designed for functional programming.

Tags can be used to define the semantic attributes of its referenced content related to the process. Tags do not limit the programming of a process, and it does not matter whether a semantic strong programming language is used. A process involving people may be tagged with social attributes by either side of the collaborating parties. There may be access controls on tags via users, groups, and the general public. A user generally has the ability to compose and practice on namespaces unless enforced by a semantic strong process. For example, a process typically handles text but a video may be supplied by a user. A side process may be used to assist the user to make a decision or select a conversion process.

Certain principles should be kept in mind in constructing a namespace. Set logics, such as union, bind, export, import, etc., may be used to make processes linked in a hierarchy. Use of open ended tags may call for input by a user and when the process proceeds to an open input, a corresponding form may be displayed to a user. The tags may need to be placed in specified types or formats or may have to be converted to ensure that certain logical steps, such as bind, work properly. URLs may also be tagged so that they can serve as APIs.

Text or data used to represent a person may be tagged to create a personal process. This may be a staged task that can receive any number of tags and output any number of tags. Tags can alter the namespace or create a new process during operation. Thus, the use of tags in a namespace forms a type of meta-programming.

Access controls may be incorporated into the use of tags and name spaces. For example, manipulating namespaces using mount or export logic may require a strong user authentication. Each tag may have an access control and may be used to hide an actual source since it is passed as reference, e.g., hide/seal a user ID. A process can be marked with additional attributes that can be used by other tools (e.g., rules engine, alarm, logger, personal helper, semantic analysis, etc.).

On a personal name space, the tags may be formed in any distributed way depending on user's needs with or without actual programming and regardless of whether a semantic strong programming language is used. On the user side, the user may control the iteration. On the server side, the amount of data is enforced on each user or session (e.g., Twitter-like API). A user may typically create a new process on his or her device. A server may accept rules made up in a rules engine or link to another machine that also supports a namespace. The rules engine may be a part of the platform and may include a set of basic rules that can be invoked by users. Users may, however, create their own rules within their respective namespaces. The rules within the rules engine and the rules created by users comprise a rules library. Users are allowed to use components provided by a server or other user/group on their devices. The system uses methods known in the art to protect the integrity of components used (e.g., checksum).

When using tags, it may be desirable to use an inversion of control programming practice. A namespace links unstructured tags into usable structures. A tag itself may be a URL, and tagging a tag may create further indirection. Depending on processes, inversion of control may be used on server side implementations, e.g., to handle an unknown or changeable process with dependency injected based on application context.

Various embodiments of the present invention will now be described in greater detail with reference to the accompanying drawings.

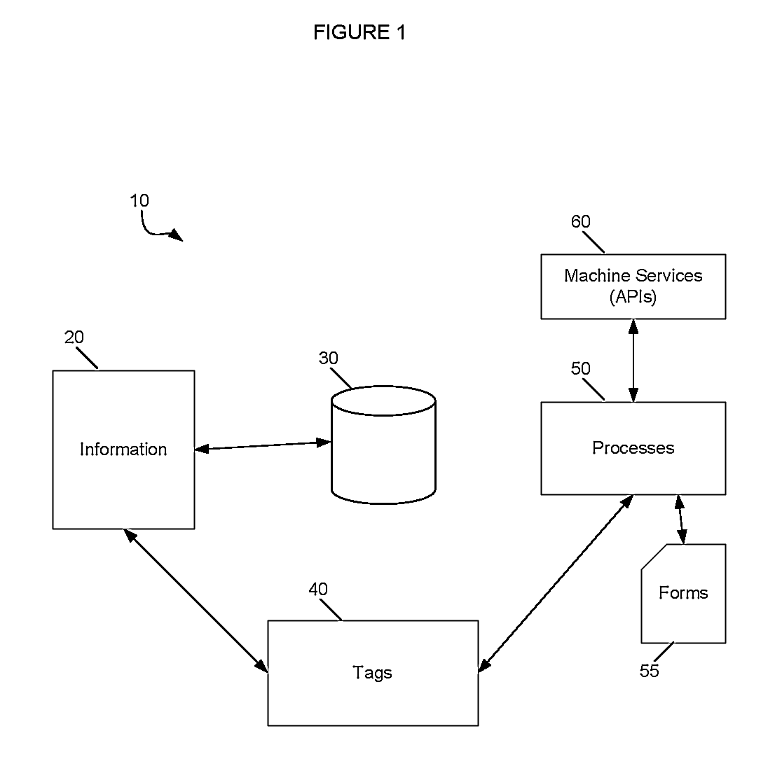

FIG. 1 illustrates an exemplary arrangement of a namespace of tags in a human-centric distributed network operating system in accordance with an embodiment of the present invention. Namespace 10 discloses a hierarchy of processes linked together into certain structures or patterns to provide a communication channel between each of the corresponding functions and layers in the hierarchy. Namespace 10 includes a host of information 20, which may be culled from web sites, applications, services, etc or other accessible resources. An individual may be associated with one or many namespaces based on collaboration needs, and namespace 10 may include shared parts, e.g., friends, groups, the general public, etc. For example, information 20 may be web page content, such as text, images, video, etc. Information 20 may be stored in central managed database 30 or other resources, e.g., with other service applications running in a cloud computing arrangement. Information 20 may be assigned tags 40. As discussed herein, each tag includes a “name” and may provide a description or simply a reference to a piece or portion of information 20. Each piece or portion of information 20 may be associated with multiple tags. It should also be understood that tags 40 may be colored tags.

In addition to being associated with information 20, tags 40 may concern persons, groups, processes (e.g., application programming interfaces (APIs)) or tasks, resources, etc. Tags 40 may be associated with individual users or processes, which are identified in FIG. 1 as processes 50. Processes 50 may be used for performing service applications and typically utilize profiles, attributes, tags, etc. Processes 50 may be associated with specific users and may involve user input. Processes 50 may include the use of forms 55, which may be pre-filled or require user input or both. Forms 55 may be viewable and shared among users during part of a remote process, e.g., the performance of service applications. Alternatively, forms 55 need not be shared and may be controlled by a single user. Processes 50 interface with machines services (APIs) 60 at various points to facilitate operation and performance. Machine services (APIs) 60 may include a number of distributed components, such as processors, servers, databases, etc., for facilitating the operation and performance of processes 50.

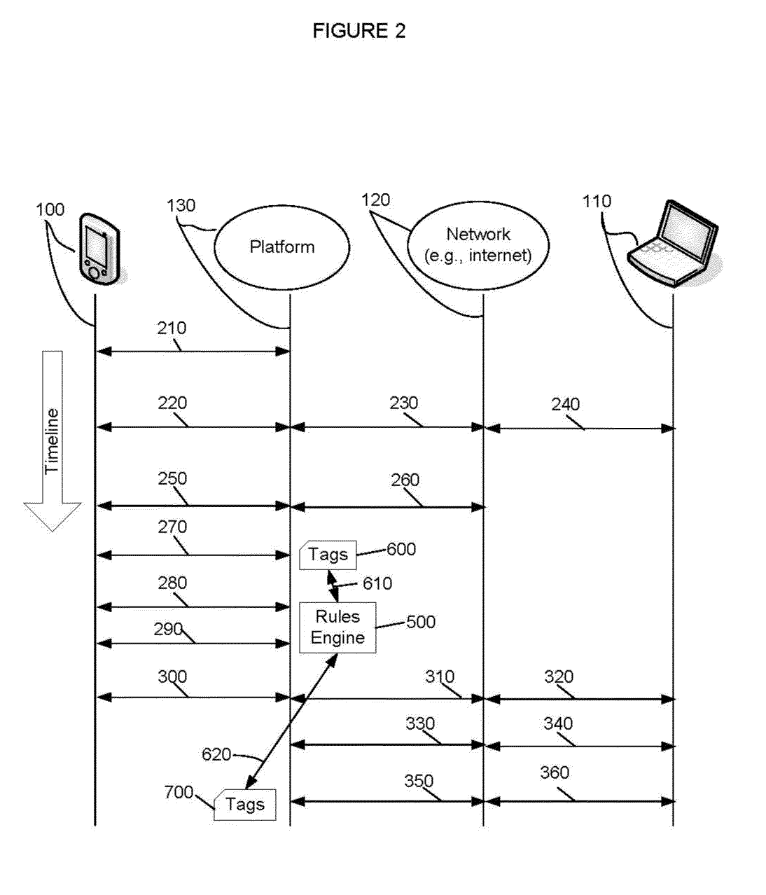

FIG. 2 illustrates an exemplary arrangement of a system environment and a process distribution of a human-centric distributed network operating system in accordance with an embodiment of the present invention.

The system environment comprises one or more user devices 100; one or more third party devices 110; network (e.g., Internet) 120 that may include domains, web sites, applications, services, etc.; and platform 130 that may be part of a human-centric distributed network operating system. Platform 130 may include a number of distributed components for facilitating communications in the system environment. For example, platform 130 may include an application program interface (API) server and a web server to provide programmatic and web interfaces respectively, that may in communication with one or more application servers for facilitating social applications. Platform 130 may include components such as a processor, a memory, a network interface controller, a hard drive, a graphics card, etc. The application servers of platform 130 may be connected to or in communication with one or more database servers that facilitate access to one or more databases. Platform 130 may include rules engine 500, tags 600, and tags 700, among other items. In alternative configurations, different or additional modules can be included in the system. Implementations of the invention may operate in network environments that include multiples of one or more of the individual systems and devices disclosed herein. Other implementations may operate in network environment where one or more of the systems or devices described herein have been omitted. Platform 130 is operative to support process flows directed to, for example, enabling communications among users, configuring rules, executing rules, facilitating namespace interaction, and the like. In one implementation, the functionality of platform 130 may be hosted by one or more physical servers that may include web or HTTP servers, FTP servers, and the like.

The one or more user devices 100 comprise one or more computing devices that can receive user input and can transmit and receive data via network 120. For example, user devices 100 may be a desktop computer, a laptop computer, a smart phone, tablet, or any other device including computing functionality and data communication capabilities. The user devices 100 are configured to communicate via network 120, which may comprise any combination of local area and/or wide area networks, using either wired or wireless communication systems. The third party devices 110 may similarly include a desktop computer, a laptop computer, a smart phone, or any other device including computing functionality and data communication capabilities.

Network 120 may include social networking websites among other things. The social networking websites may store member profiles that describe the members of a social network, including biographic, demographic, and other types of descriptive information, such as work experience, educational history, hobbies or preferences, location, and the like. The website may further store data describing one or more relationships between different members. The relationship information may indicate members who have similar or common work experience, group memberships, hobbies, or educational history. Additionally, the social networking website includes member-defined relationships between different members, allowing members to specify their relationships with other members. For example, these member defined relationships allows members to generate relationships with other members that parallel the members' real-life relationships, such as friends, co-workers, partners, and so forth. Members may select from predefined types of relationships, or define their own relationship types as needed.

A scenario of process distribution in a human-centric distributed network operating system in accordance with an embodiment of the present invention will now be described with reference to FIG. 2. In accordance with the process timeline illustrated in FIG. 2, in process step 210, a user device 100 communicates with platform 130 providing a human service infrastructure for social network applications to construct a namespace. Process step 210 may be considered a local process as it involves a user communication with platform 130. In process steps 220, 230, and 240, communications may be transmitted among the user device 100, platform 130, network 120 (e.g., social networks), and third party devices 110. The communications of process steps 220, 230, and 240 may be thought of as a human process involving communications between user device 100 and third party devices 110. In process steps 250, and 260, a user may retrieve resources based on tags from web sites or other online information available on network 120 at any point in the process. These process steps may be considered a local process involving a single user.

In process step 270, user device 100 may use a remote process call to access platform 130 for generating or selecting tags 600 for use in the process. The results of this remote call procedure may be communicated to user device 100. Process step 270 may be understood to be a remote process involving server communication with a user. As shown in process step 280, user device 100 may access platform 130 to invoke rules engine 500 to access tags 600 via communication 610 to create a new process on his or her device. In a preferred embodiment, platform 130 may accept rules generated by rules engine 500 or link to a database (not shown) that also supports a name space. Process step 280 may be treated as a local process involving client side communication between user device 100 and platform 130. At this point in the process distribution it should be understood that a namespace has been constructed and is ready to be exported for sharing. Referring still to FIG. 2, the namespace may be exported between platform 130 and user's device 100 as shown in human process step 290. In human process steps 300, 310, and 320, communications may be transmitted among user's device 100, platform 130, network 120, and third party devices 110. As shown in local step 330 of FIG. 2, the namespace may be mounted to network 120 (e.g., social network websites) and made available to third party devices 110 in local process step 340. As shown in remote process steps 350 and 360, interested third parties may use third party devices 110 to fill in an electronic form and communicate that information back to the platform 130 via network 120 using tags 700. Rules engine 500 of platform 130 may receive tags 700 via communication link 620 and transmit results to user device 100 as shown in local step 280. It should be noted that tags 600 and tags 700 may be colored tags. The user by way of user device 100 may collaborate with the third party by sending and receiving communications to third party device 110 to negotiate the terms of the service to be performed, including but not limited to the value exchanged for performing the service. User device 100 may transmit further communications between third party device 110 through network 120 in connection with the service request.

Using the exemplary scenario of a system environment and a process distribution illustrated in FIG. 2, a system and method for facilitating the performance of a service by use of a network-based platform is provided.

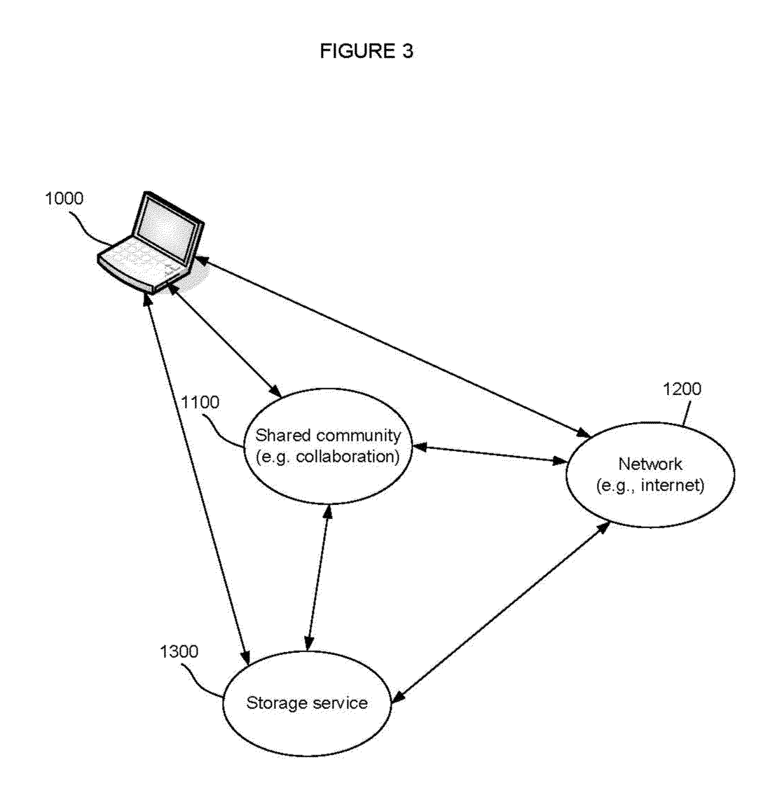

FIG. 3 illustrates an exemplary arrangement for using colored tags in a system environment in accordance with an embodiment of the present invention. A user device 1000 may be a desktop computer, a laptop computer, a smart phone, or any other device including computing functionality and data communication capabilities. User device 1000 is configured to communicate with network 1200, which may comprise any combination of local area and/or wide area networks, using either wired and wireless communication systems. On user device 1000, images and other data may be displayed and used with colored tags, a graphics processing unit (GPU) embedded in user device 1000, and meta-programming code for handling graphic effects, such as crop, fuse, transform, zoom, smoke, shadow, etc. GPU may include graphic accelerators to permit the real-time streaming of images and videos. In connection with images and other data, user device 1000 may perform aggregating, caching, and semantic processing, such as crop, fuse, transform, zoom, etc. User device 1000 is also configured to communicate with shared community 1100 and storage service 1300. As illustrated in FIG. 2, shared community 1100 and storage service 1300 are in communication with other and with network 1200 and may engage in specific communications as a result of commands or requests transmitted by user device 1000. Storage service 1300 may include any storage or database system that may be used by a distributed system. Storage system 1300 provides a cache for static content and may enable performance enhancement. For example, storage system 1300 may be any suitable storage or database system, such as may include Hypertable, http://www.hypertable.org/, or other similar systems. Shared community 1100 may facilitate collaboration among user device 1000 and other user devices in a human-centric distributed network operating system.

In one embodiment of the invention, a pixel browser application using colored tags is provided. The pixel browser application generally allows a user of a device to virtually browse a retail store and control the browsing by use of the device based on the desires of the user. For example, video and/or images of various portions of a retail store are controlled by a device associated with the store. The device associated with the store may be a server or other computer hardware system. Video or a stack of pictures of the retail store may be streamed to a user device in real time in accordance with user actions. For instance, a user may use the user device mouse to navigate through the retail store or click on the streaming video or images to enhance the visual image or create other visual effects in order to improve the browsing experience, such as to better view the particular desired merchandise that may be available in the retail store.

For the device associated with the store, the video and/or images are assigned colored tags to permit performance of desired operations. For example, the pictures may be stacked and tagged with semantic processes that may be new or re-used. The device associated with the store handles look ahead two dimensional sequences based on moving directions, accelerates the image processing for communication to a user device, and caches the results by fusing images based on semantics.

In another embodiment of the invention, a visual programming application using colored tags is provided. The visual computer application generally allows a user of a device to develop and run a desired application by compiling components that appear as icons or images in a graphical user interface. The components may be available on either a server or cached on a user's computer. The components may be assembled in a library and run on a user's computer, such as buttons on a calculator. Other components may be service applications running in a cloud computing arrangement. Users may also design and contribute components for their own purpose or group collaboration via a distributed computing arrangement. The system thus has some similarity to a graphic-based programming environment, such as Laboratory Virtual Instrumentation Engineering Workbench (LabVIEW). However, every image in the graphical user interface and every programming component are assigned a colored tag for purposes of running applications. In this way, the graphical user interface with the colored tags provides a visual guide for highlighting and correlating inputs and outputs of the visual programming application.

In accordance with the visual programming application, a user may change image views in any manner desired. A user may also control which image part of any shape corresponds to particular semantic or non-semantic meaning, such as 2D or 3D animations. A user may export his or her processes, e.g., the whole bulletin board and set access restrictions, for a variety of potential uses. For example, such an export may allow a user's friends to take action on the user's processes in lieu of the user. Such an export allows users to make their processes part of other people's processes. For instance, a user may make an announcement in a bulletin board publicly available on a network (e.g., a job posting) that may be automatically linked to a user's bulletin board to allow other people of interest to the user to make inputs. Thus, a user may make his or her processes part of other peoples' processes. In this manner, a visual programming application may be realized.

In some example embodiments, a system for facilitating the performance of a personal service using a human-centric distributed network operating system that provides a human service infrastructure for social network applications is provided. For example, the user may make a request for performance a specified requested service using tags. The platform may receive certain other information in connection with the request from the user. For example, the user may specify certain information associated with the request, e.g., a time period for performing the requested delivery, a location for the desired delivery of the specified product, and an amount that the user may be willing to pay for the delivery of the specified product, all of which may be specified by tags. These various conditions may be specified by a rules engine, accessed from a database, or created by a user. Next, in some embodiments, the network based platform may communicate or make available the request to other users of the network-based platform. The data transmitted by the communication may include tags specifying certain information about the request, such as the particular service requested, a time period for providing a particular product, a location for delivery of the product, and the amount the requester may be willing to pay for the service. Then, in some embodiments, third party users may respond to the communication. Third party user responses may take many forms. Tags may be used to transmit user responses. For example, a third party user response may be transmitted to the requestor.

The network-based platform conveys the third party user response information to the user device. The requestor and third party user may continue to negotiate, collaborate, and communicate as necessary. The network-based platform may relay various communications between the responding third party user and the user device until the request is accepted by both parties or rejected by either party. Upon acceptance of the specified conditions, the third party responding user performs the specified service in exchange for the agreed-upon payment for the service.

As another example of a particular application of the disclosed system, a user seeking to have a service performed may initiate a request using a user device. The service to be performed may include the delivery of certain specified information or documents about a given topic or item of interest. The user may specify a desired time period for providing the information sought, particular details or specifying characteristics about the topic or item of interest that may be indicative of the desired information, and an amount that the user may be willing to pay for delivery of the desired information, all of which may be specified by tags. Next, in some embodiments, the network based platform may communicate or make available the request to third party devices. The communication may provide certain specified information about the request using tags, as described. Then, in some embodiments, third party users may use tags to respond to the communication. The network-based platform conveys the third party user response information to the user. Here, multiple third party users may further transmit and receive communications with the user in this manner as desired. Upon acceptance of the specified conditions, the responding third party users may search for the specified desired information. The desired information may be located in any number of manners, e.g., by performing searches using online search engines, researching publicly available databases, traveling to a location where the desired information may be obtained, etc. Upon obtaining the desired information, the responding third party user delivers the desired information. After reviewing the delivered information, the platform facilitates the determination of whether the information provided comports with the information sought by the user. If it is determined that the information meets the request, the user pays the responding third party user the agreed-upon payment for performing the service.

Those skilled in the art will recognize that the features of the present disclosure are not limited to facilitating the performance of services sought by individuals but may also include facilitating the performance of services sought by businesses, companies, and other organizations. In an example, a company that sells products on its web site and devotes a portion of its web site to user generated content may also wish to use its web site to provide customer service. The company may contact fans of the company's products to handle customer service requests in exchange for payment for performing the service. Sources for identifying fans may include users who posted content to the company website or other online resources available to the company, such as Facebook pages, Twitter feeds, etc. In one embodiment, a company may contact suspected company fans with an offer to handles customer service inquiries using tags. A fan of the company may agree to respond to specific customer inquiries for specified times on specified dates in exchange for payment from the company. The fan's response to the company may employ tags. The fan and the company agree that the fan may handle the customer service inquiries in an agreed-upon manner, such as by responding to email questions from customers, conducting online chat sessions, etc. Upon performing the requested customer service, the company may pay the fan the agreed-upon payment for performing the service.

In another embodiment, an application to facilitate the sale and exchange of private placement stock using the platform in a human-centric distributed network operating system is provided. Under the Jumpstart Our Business Startups (JOBS) Act, startup companies and small businesses may seek broad sources of investment in their companies, including crowd funding. Such startup companies and small businesses may use the disclosed platform in a human-centric distributed network operating system to obtain funding for their businesses. This capital raising application may use the technology and features discussed herein to negotiate, collaborate, and exchange ideas and money as necessary and mutually agreeable among the companies and interested investors.

The architecture is designed in a manner to be highly scalable. A managed switch proxy approach may be used to handle scalability and load balancing issues associated with multi-party collaboration regardless of whether synchronization is needed. Communications between data centers and individual devices may be accomplished through a media gateway, such as Session Initiation Protocol (SIP) and/or Signaling System 7 (SS7). Initiation may be accomplished through a single sign-on event.

Collaborations may be in the form of a service exchange and a service may involve various forms of contracts. There are APIs to handle Hyper Text Markup Language (HTML) or other forms. There are well-understood rules that may be available in a rules engine of the platform. The platform itself has social network features, e.g., blogs, microblogs, tags, groupware, etc. to provide an outlet for user opinions. Based on these comments and internal improvements, the platform makes usage enhancements for how to use tags in social communications. There are APIs that can be used by people/service to view the status of network/communication or control network/communication at certain level. Users can use graphic APIs to make their user interface via colored-tags. The platforms may include a programming library and applications that can be loaded or run on-the-fly by users.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, or entirely in hardware elements. Also, the particular division of functionality between the various system components described herein is merely exemplary and not mandatory; functions performed by a single system component may instead be performed by multiple components, and functions performed by multiple components may instead performed by a single component. Additionally, although the foregoing embodiments have been described in particular contexts, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

Although illustrative embodiments have been shown and described herein in detail, it should be noted and will be appreciated by those skilled in the art that there may be numerous variations and other embodiments that may be equivalent to those explicitly shown and described. For example, the scope of the present invention is not necessarily limited in all cases to execution of the aforementioned steps in the order discussed. Unless otherwise specifically stated, terms and expressions have been used herein as terms of description, not of limitation. Accordingly, the invention is not to be limited by the specific illustrated and described embodiments (or the terms or expressions used to describe them).

What is claimed is:

1. A human-centric distributed network operating system capable of facilitating collaboration among a plurality of user computing devices comprising:
a first namespace capable of constructing a first hierarchy of tags available for use by a first individual user computing device;
a second namespace capable of constructing a second hierarchy of tags available for use by a second individual user computing device; and
a third namespace associated with a server that is capable of receiving and transmitting hierarchies of tags to and from the first and second individual user computing devices;
wherein said server allows the first user computing device to share a portion of the first namespace with the second individual user computing device to use the first namespace or a portion thereof for implementing collaboration among user computing devices.

2. The system of claim 1, wherein the namespace formed by the tags associated with the resources received from the first user computing device may be shared with the second individual user computing device.

3. The system of claim 1, wherein the tags are used to identify an item that may play a role in implementing collaboration among user computing devices.

4. The system of claim 1, wherein any resource that may be tagged includes text, images, videos, network connections, computing or non-computing devices, computing or non-computing processes, computing or non-computing services, natural resources, financial resources, or human resources.

5. The system of claim 1, where any resource may be associated with a plurality of tags.

6. The system of claim 1, where the tags are associated with colors for another dimension of differentiation to perform operations associated with handling applications, such as imaging related operations or graphic user interfaces.

7. The system of claim 1, wherein the third namespace includes a rules engine.

8. A human-centric distributed network operating system capable of facilitating collaboration among a plurality of user computing devices comprising:
a namespace capable of constructing a hierarchy of tags available for use by a first individual user computing device;
a server capable of (i) receiving tags, tagged resources, or a hierarchical structure of tags from individual user computing devices, (ii) transmitting tags, tagged resources, or the hierarchical structure of tags to individual user computer devices, (iii) storing tags, tagged resources, or a hierarchical structure of tags for access by individual user computing devices, and (iv) processing tags associated with the resources under a defined set of operations; and
a rules engine capable of generating rules to operate in the hierarchical structure of said tags;
wherein said server allows the first user computing device to share a portion of the namespace with the second individual user computing device to use the namespace or a portion thereof for implementing collaboration among user computing devices.

9. The system of claim 8, wherein the namespace formed by the tags associated with the resources received from the first user computing device may be shared with the second individual user computing device.

10. The system of claim 8, wherein the tags are used to identify an item that may play a role in implementing collaboration among user computing devices.

11. The system of claim 8, wherein the rules engine includes a database for storing said rules with learning capability.

12. The system of claim 8, wherein the rules generated by the rules engine comprise tags.

13. The system of claim 8, wherein any resource that may be tagged includes text, images, videos, network connections, computing or non-computing devices, computing or non-computing processes, computing or non-computing services, natural resources, financial resources, or human resources.

14. The system of claim 8, where any resource may be associated with a plurality of tags.

15. The system of claim 8, where the tags are associated with colors for another dimension of differentiation to perform operations associated with handling applications, such as imaging related operations or graphic user interfaces.

16. A human-centric distributed network operating system capable of facilitating collaboration among a plurality of user computing devices comprising:
a processor capable of processing resources from a first user computing device and processing tags associated with the resources from the first user computing device to form and modify a namespace for the first user computing device, or a namespace for a server;
a network interface controller capable of receiving data from the first user computing device and transmitting and receiving data between a network server for access by a second user computing device; and
a memory for storing data and tags associated with the data;
wherein said system allows the second user computing device to use the resources, shared by the first user computing device or the server in the form of tags, in a namespace for the second computing device to implement collaboration among user computing devices.

17. The system of claim 16, wherein the namespace comprises a structured hierarchy of tags.

18. The system of claim 16, wherein the namespace formed by the tags associated with the resources received from the first user computing device may be shared with the second user computing device.

19. The system of claim 16, wherein the tags are used to identify an item that may play a role in implementing collaboration among user computing devices.

20. The system of claim 16, wherein any resource that may be tagged includes text, images, videos, network connections, computing or non-computing devices, computing or non-computing processes, computing or non-computing services, natural resources, financial resources, or human resources.

21. The system of claim 16, where any resource may be associated with a plurality of tags.

22. The system of claim 16, where the tags are associated with colors to offer another dimension of differentiation to perform operations associated with handling applications, such as imaging related operations or graphic user interfaces.

23. A method of collaborating among a plurality of user computing devices in a human-centric distributed network, comprising:
providing a namespace capable of constructing a hierarchy of tags available for use by a first individual user computing device;
providing a server capable of receiving tags, tagged resources, or a hierarchical structure of tags from the first individual user computing device transmitting tags, tagged resources, or the hierarchical structure of tags from the server to the first individual user computer devices;
permitting the first user computing device to share a portion of the namespace with a second individual user computing device to use the namespace or a portion thereof for implementing collaboration among user computing devices.

24. The system of claim 23, where the tags are associated with colors to offer another dimension of differentiation to perform operations associated with handling applications, such as imaging related operations or graphic user interfaces;

25. The method of claim 23, wherein any resource that may be tagged includes text, images, videos, network connections, computing or non-computing devices, computing or non-computing processes, computing or non-computing services, natural resources, financial resources, or human resources.

26. The method of claim 23, wherein any resource may be associated with a plurality of tags.

27. The method of claim 23, wherein the namespace comprises a structured hierarchy of tags.
